(19) United States
(12) Patent Application Publication
(10) Pub. No.: US 2017/0206337 A1
(43) Pub. Date: Jul. 20, 2017

(54) SYSTEM FOR DISEASE MANAGEMENT THROUGH RECOMMENDATIONS BASED ON INFLUENCER CONCEPTS FOR BEHAVIOR CHANGE

(71) Applicant: Conduent Business Services, LLC, Dallas, TX (US)

(72) Inventors: Michael David Shepherd, Ontario, NY (US); William K. Stumbo, Fairport, NY (US); David R. Vandervort, Walworth, NY (US); Karen M. Braun, Fairport, NY (US); Jennie Echols, Cumming, GA (US)

(21) Appl. No.: 15/000,529

(22) Filed: Jan. 19, 2016

(51) Int. Cl. G06F 19/00; G06F 21/62; G09B 19/00; G06F 17/30

(52) U.S. Cl. CPC G06F 19/3475; G06F 19/3431; G06F 19/3437; G06F 17/3053; G06F 21/6245; G09B 19/00

(57) ABSTRACT

A system generates an automated survey and causes a user interface of an electronic device to present survey to a patient, so that the system can use the survey responses to identify and provide wellness or disease management content items that are tailored to the patient's behavioral needs. The system automatically generates an electronic survey document with data entry fields that each correspond to a question for a category of behavioral influence. The document includes fillable fields as presented on a user interface. When the system receives data via the fillable fields as presented on the user interface of the electronic device, it will assign a value to each response, construct a patient model, and it will use the patient model to extract intervention content items and provide the patient with those items.

### BACKGROUND

Many people struggle to improve their wellness, especially when they are trying to manage one or more diseases such as type-2 diabetes, hypertension, and chronic obstructive pulmonary disease. In the most challenging situations, people work with care managers and behavioral coaches to improve their wellness. This involves frequent conversations with a clinical expert who leverages various theories of behavior change, such as Motivational Interviewing, to learn about, empower, and assist the person in ways that are most effective for managing their chronic condition.

Despite these efforts, nearly half of U.S. healthcare consumers do not take their medications as prescribed by their doctors. Poor medication adherence poses serious and unnecessary health risks, and costs the U.S. healthcare system over $100 billion and 125,000 deaths annually. Studies have shown over 40% of non-adherent consumers make their own self-reasoned decisions about whether to use a medication.

Medication adherence is just one facet of disease management and general wellness. People with complex diseases, such as type-2 diabetes, have a wide range of disease management facets to consider. Even individuals just trying to maintain a state of general wellness are constantly confronted with challenges which influence their behavior.

This document describes devices and methods that are intended to address issues discussed above and/or other issues.

### SUMMARY

This document describes a method and system for selecting content for wellness or disease management and delivering the content to a patient. In an embodiment, the system includes a processing device, a display device, a database of intervention content, and a non-transitory memory containing programming instructions that are configured to cause the processing device perform the selection and presentation. The system may identify a medical condition of a patient and automatically generate an electronic survey document comprising a set of data entry fields, in which each data entry field corresponds to a question that corresponds to a category of behavioral influence, and wherein each category corresponds to a domain of desired patient activity. The system's processing device will cause the display device to output the survey document to the patient as at least a portion of a user interface. When the system receives responses to the questions via the fillable fields as presented on the user interface, it will assign a value to each response. For each of the categories, the system uses the values of the responses to calculate a patient-specific measure of behavioral influence for each domain with which the category is associated. The system may also automatically construct a patient model so that the model comprises the calculated patient-specific measures of behavioral influence for each domain and category. The system will use the model to determine one or more dominant categories of behavioral influence for the patient for each domain. The system will also periodically access the database of intervention content and use the model to extract one or more intervention content items for the patient so that each extracted intervention content item is associated with the medical condition, a domain that relates to the medical condition, and a dominant measure of behavioral influence for the patient as determined from the model. The system will then cause the display device to output the extracted one or more intervention content items to the patient.

Optionally, when extracting the one or more intervention content items, the system use the model to rank a set of candidate content items and extract candidate content items having a rank that exceeds a threshold.

In some embodiments, when calculating the patient-specific measure of behavioral influence for each domain, the system may use the assigned values for each response to assign a value to a plurality of facets of behavioral influence for the domain.

In some embodiments, when automatically constructing the patient model for each category, the system may save the values of each facet of behavioral influence for each domain to an electronic file in a memory device. It may also include in the model an assessment of the patient's perceived severity level, or of the patient's perceived susceptibility to disease or about having a complication.

In some embodiments, when extracting and outputting the one or more intervention content items, the system may select a first intervention content item associated with behavioral areas in the model for which the patient is relatively strong, select a second intervention content item associated with behavioral areas in the model for which the patient is less strong, and output both the first intervention content item and the second intervention content item to the patient.

In some embodiments, when extracting and outputting the one or more intervention content items, the system may extract a first intervention content item and cause the display device to present the first intervention content item to the patient each time the patient accesses the user interface until the patient either selects the first content item for viewing, or fails to select the first intervention content item for viewing after a threshold number of access events. After the patient either selects the first intervention content item for viewing or fails to select the first content item for viewing after a threshold number of access events, then, when the patient next accesses the user interface, the system may extract a second intervention content item and present the second content item to the patient.

In some embodiments, when extracting and outputting the one or more intervention content items, the system may extract and output at least a first content item that is associated with positive aspects of the model and a second content item that is associated with one or more behavioral influences for which the patient needs improvement.

In some embodiments, when extracting and outputting the one or more intervention content items, the system may: (i) select a primary category of behavioral influence from the dominant categories of behavioral influence; (ii) assign a first score to each intervention content item that matches the primary category, so that each intervention content item that matches the primary category has a common score value; (iii) assign a second score to each intervention content item that does not match the primary category, so that the intervention content items that do not match the primary category have various values and are assigned a score value that is less than the common score value; compare self-efficacy values for the patient against the score values assigned to each intervention content item and normalize the score values for each intervention content item based on the intervention content item's distance from the self-efficacy values; and (iv) use the normalized score values to identify the intervention content items that are extracted. Optionally, before the comparing, the system may increase the score values for content that is associated with the category for which the patient has at least a threshold self-efficacy value.

### BRIEF DESCRIPTION OF THE DRAWINGS

FIG. 1 depicts example elements of a system for selecting personalized content and delivering the content to a patient.

FIG. 2 depicts an example of a survey document.

FIG. 3 depicts aspects of a simple model of patient-specific measures of behavioral influence.

FIG. 4 depicts aspects of a more detailed model of patient-specific measures of behavioral influence.

FIG. 5 is a process flow diagram illustrating various steps that a patient survey and recommendation system may perform.

FIG. 6 illustrates an example of an intervention content item.

FIG. 7 depicts various embodiments of one or more electronic device for implementing the various methods and processes described herein.

### DETAILED DESCRIPTION

This disclosure is not limited to the particular systems, methodologies or protocols described, as these may vary. The terminology used in this description is for the purpose of describing the particular versions or embodiments only, and is not intended to limit the scope.

As used in this document, any word in singular form, along with the singular forms “a,” “an” and “the,” include the plural reference unless the context clearly dictates otherwise. Unless defined otherwise, all technical and scientific terms used herein have the same meanings as commonly understood by one of ordinary skill in the art. All publications mentioned in this document are incorporated by reference. Nothing in this document is to be construed as an admission that the embodiments described in this document are not entitled to antedate such disclosure by virtue of prior invention. As used herein, the term “comprising” means “including, but not limited to.”

In this document, the term “electronic device” refers to a device having a processor and a non-transitory, computer-readable medium (i.e., memory). The memory will contain programming instructions in the form of a software application that, when executed by the processor, causes the device to perform one or more processing operations according to the programming instructions. An electronic device also may include additional components such as a touch-sensitive display device that serves as a user interface, as well as a camera or other image capturing device. An electronic device also may include one or more communication hardware components such as a transmitter and/or receiver that will enable the device to send and/or receive signals to and/or from other devices, whether via a communications network or via near-field or short-range communication protocols. Examples of electronic devices include smartphones, smart watches, digital cameras, tablet computing devices, electronic readers, personal computers, multi-function devices, fitness tracking devices, wearable electronic devices, media players, satellite navigation devices and the like.

An “image capturing device” or “imaging device” refers to any device having one or more image sensors capable of optically viewing an object and converting an interpretation of that object into electronic data. One such example of an imaging device is a digital camera.

In this document, the term “patient” refers to an individual having a medical condition, and who may use the systems described in this document to influence or receive information about treatment or management of a medical condition, or for promoting a healthy lifestyle while living with that condition. A “patient” also may refer to an individual who is not seeing information about, or who may not have, a specific disease but who instead is using the system to obtain information to help promote his or her overall health and wellness.

Many existing web-based applications and smartphone applications provide significant opportunities for a patient to become educated about his or her conditions, get reminders to take or refill medications, track their goals, and otherwise stay engaged with their health. These tools engage the user in a myriad of ways from elaborate gamification to simple nagging. However, the existing systems do not identify the activities and external factors that are likely to drive actual behavioral change of the patient.

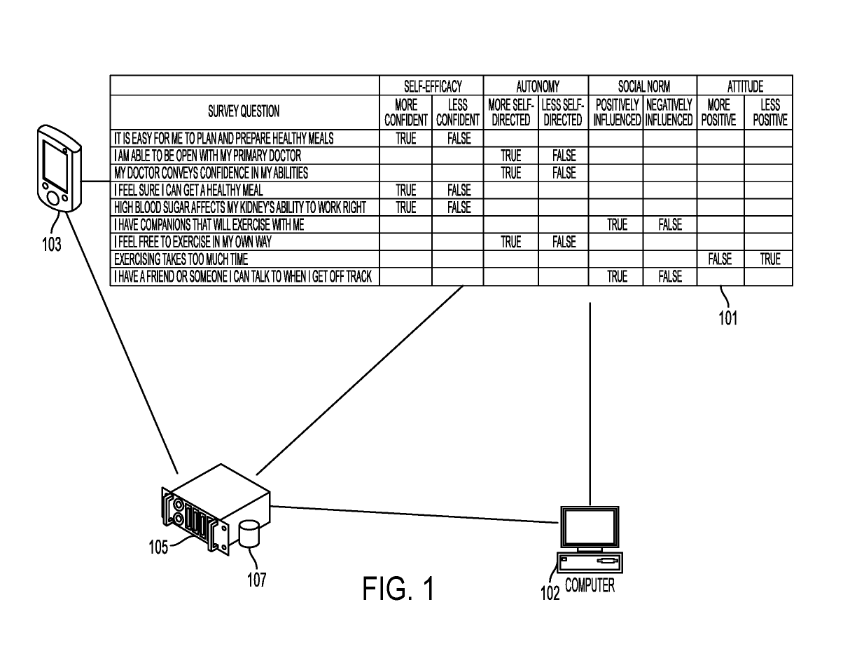

FIG. 1 illustrates example components of a system for surveying a patient and providing the patient with content for disease management. The system may include one or more user electronic devices 102, 103 such as mobile electronic devices and/or desktop electronic devices. A server 105 includes a processor and programming instructions that cause the server and/or other electronic devices to perform various functions described in this document. The server or electronic device may generate an electronic file of a survey document 101 that the system uses to collect information from or about a patient. The server also may have access to a data storage facility 107 (i.e., one or more memory devices) that stores rules and/or data, such as the user model, electronic document files, and patient history data that will be described below.

The various components shown in FIG. 1 may be communicatively connected via one or more communication protocols, such as via a Wi-Fi network, via another communication network such as the Internet or a mobile phone network, or using a short-range or near-field communications protocol such as Bluetooth, Bluetooth Low Energy, radio frequency identification (RFID) or other protocols. Various steps of the process described below may be performed by the processing device of the server 105, processors of the electronic devices 102, 103, or by a combination of these components. Similarly, data and programming instructions that the system uses to perform the methods described below may be stored on computer-readable media contained within any combination of these devices and/or other devices to which any of the devices are directly or indirectly communicatively connected.

The system described in this document identifies and generates personalized intervention content for disease management and general wellness. The personalization of interventions is accomplished with a behavior-influencer user model and an intervention recommender. The initial intervention content is targeted to a behavior influencer concept in which the patient is most ready to make a behavior change. As the patient experiences successes by performing the interventions, interventions are recommended that are progressively more challenging for the patient to make a behavior change.

The system constructs a behavior-influencer user model for a patient. Such a model may capture well-established influencer concepts from key behavior change theories. The system develops the model based on an automatically generated and electronic device-delivered survey that evaluates the patient's strengths and weaknesses in various behavior influencer concepts. The concepts may be selected from behavior change theories such as Self-Determination Theory and The Theory of Planned Behavior. Examples of behavior influencing concepts include self-efficacy, autonomy, social norming, attitude, and loss aversion. The system may identify, assign and rank survey questions against these concepts. As the patient provides answers to the questions, the system generates a user model instance for the patient.

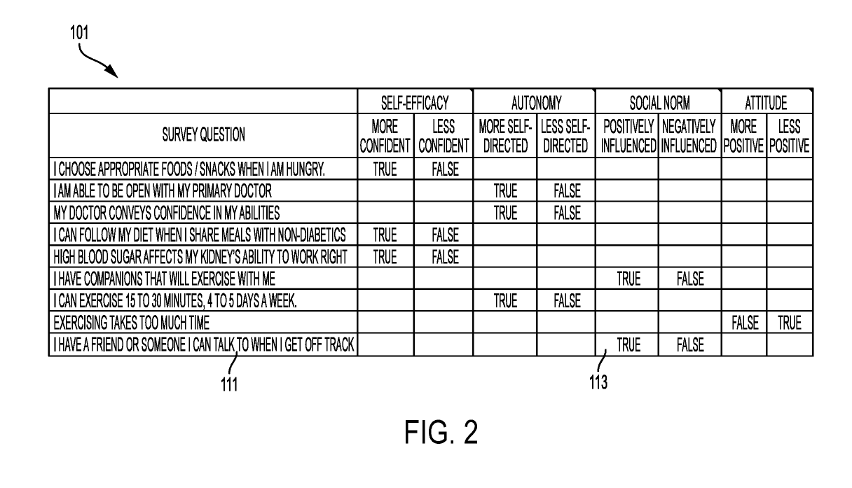

FIG. 2 illustrates an example of the relationships 101 of patient survey questions with the various concepts from behavior change theories. These relationships are acquired through the use of survey documents that may be represented as an electronic data file. The survey document includes survey questions and a set of fillable fields that, when presented on a display device, provide areas in which a patient may use a user interface of the device to input data into the fillable field. The user interface may be, for example, a mouse and keyboard, a touch screen and keypad, a touch-sensitive screen and drop down menu, or other suitable devices that enable a user to enter responses to the survey questions in the questions' corresponding fillable fields. A fillable field is a sector of the user interface, such as a set of coordinates of a touch-sensitive display, or a data entry field in a web browser, that may receive information from a user of the electronic device. Examples of suitable survey documents include any previous, current or future version of the Stanford Self-Efficacy Quiz (such as that available at the time of this filing at http://patienteducation.stanford.edu/research/sediabetes.html). Another example of a suitable survey document is the Medication Understanding and Use Self-Efficacy Scale (MUSE) (available at the time of this filling at http://www.ncbi.nlm.nih.gov/pmc/articles/PMC3184839/).

In the example shown in FIG. 1, the survey question “I can choose appropriate foods/snacks when I am hungry” requests that the patient provide a response on a Likert scale from “Not at all confident” (1) to “Totally confident” (10) in the question's corresponding fillable field. The system takes the user responses and adds data to the patient's model 401. If the patient indicated more confidence about this activity, and the patient's continuous measure for self-efficacy towards ‘eating healthy’ would be adjusted higher. If the patient indicated less confidence about this activity, their measure of self-efficacy would be relatively lower in the model 401. Similarly, the question “I can follow my diet when I share meals with non-diabetics” would elicit a response that the system would to adjust the patient's continuous measure of Social Norming influences in the model. A continuous measure for the corresponding behavior influencers would be adjusted higher or lower based on the patient's response to each associated survey question.

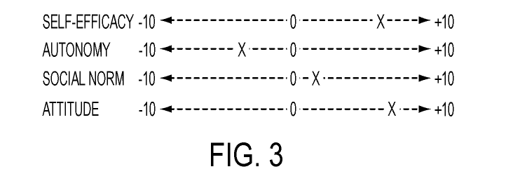

A system will generate a patient model instance that captures the patient's measures of behavior influencers. As a result of completing many survey questions, one example of a patient's set of behavioral influencers (categories of behavioral influence) could be represented using a set of continuous measures, as shown in FIG. 3, in which the ‘X’ for each influencer represents the positioning of a specific patient on the continuous measure.

The patient's measurements for each influencer may change over time as the patient provides the system with more survey question responses. Over time, responses may reflect changes in the patient's behavior as the system presents them with content tuned to their specific needs and their primary behavior influencer concepts.

The patient model reflects the system's understanding of the individual in consideration of multiple facets, including:

(1) Self-Efficacy in each of various domains. For example, the American Association of Diabetes Educators has identified seven key domain areas. These areas, known as the AADE7, include eating healthy, staying active, monitoring blood glucose, taking medication, problem solving, reducing risks and healthy coping. The system may use the AADE7 domains, or it may use other domains of interest for a different chronic or acute condition.

(2) Area of Success. An area of success is a self-identified area that the patient believes that he or she understands and will perform well in.

(3) Preferred Content Format. The system may present the patient with content in a format that the user identifies as his or her preferred format. The formatting may be done by the system itself, by an interface controller (e.g., a website or separate computing device), or other entity. The system may output the content directly to the patient, or indirectly to the patient by passing the content to the interface controller, which will in turn output the content to the patient.

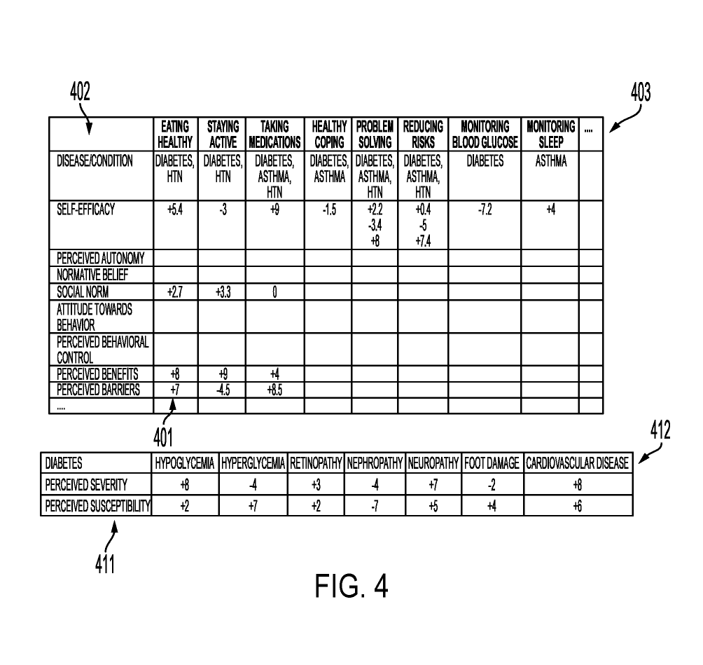

FIG. 4 illustrates an example in which a patient model has assigned patient-specific values 401 to various facets 402 of the AADE7 domains 403. In this example, the patient has several medical conditions: type 2 diabetes, asthma, and hypertension (HTN). Each condition requires management in various wellness domains 403 (e.g., Eating Healthy) that are expected to either improve disease state or slow disease progression.

For each domain 403 (which this document also may refer to as a category of behavioral influence) the system generates a measure of behavioral influence for one or more of the facets 402 using criteria defined by the particular behavior change theory that defines an influencer for change, such as the facet (influencer) of Self-efficacy for the domain (category) of Eating Healthy. In the example of FIG. 4, the system uses a scale with values from −10 to +10 to represent the assessment of each influencer for the example patient. Thus, to calculate the patient-specific measure of behavioral influence for each domain the system may use the assigned values for each response to assign a value to a variety of facets of behavioral influence for the domain. Incomplete assessments are represented as blank cells in this example instance of the patient model.

The system may use the model to assess the patient's influencers for certain domains based on a specific disease. In this example, the domains of Problem Solving and Reducing Risks could be assessed for the example patient slightly positive for diabetes, somewhat negative for asthma, and very positive for Hypertension. The Taking Medications domain could also be assessed for each disease, or even finer-grained, for each individual medication. In this example, the patient model is extensible for additional behavior change influencers, wellness domains, and disease states. The system may then select and output content items that are relevant to the disease.

In this example, the influencers may be defined using known definitions, such as the following (adapted from Wikipedia and/or other sources):

Self-efficacy may refer to an individual's belief in his or her capacity to execute behaviors necessary to produce specific performance attainments. Self-efficacy reflects confidence in the ability to exert control over one's own motivation, behavior, and social environment.

Perceived autonomy is the belief of an individual to make an informed, un-coerced decision. It reflects a person's feeling of control in their own behaviors and goals.

Normative belief is an individual's perception of social normative pressures, or relevant others' beliefs that he or she should or should not perform such behavior.

Social norm (or subjective norm) is an individual's perception about the particular behavior, which is influenced by the judgment of significant others (e.g., parents, spouse, friends, teachers). It may be considered to be an individual's perception of social norms or his/her peers' beliefs about a behavior, or a function of an individual's normative beliefs and motivation to comply with beliefs.

Attitude toward behavior is an individual's positive or negative evaluation of self-performance of the particular behavior. The concept is the degree to which performance of the behavior is positively or negatively valued. It may be determined by the total set of accessible behavioral beliefs linking the behavior to various outcomes and other attributes.

Perceived behavioral control is an individual's perceived ease or difficulty of performing the particular behavior. Perceived behavioral control may be determined by the total set of accessible control beliefs.

Perceived benefits refer to an individual's assessment of the value or efficacy of engaging in a health-promoting behavior to decrease risk of disease. If an individual believes that a particular action will reduce susceptibility to a health problem or decrease its seriousness, then he or she is likely to engage in that behavior regardless of objective facts regarding the effectiveness of the action.

Perceived barriers refer to an individual's assessment of the obstacles to behavior change. Even if an individual perceives a health condition as threatening and believes that a particular action will effectively reduce the threat, barriers may prevent engagement in the health-promoting behavior.

As shown in FIG. 4, the model can also extend the patient model with the patient's perceived severity and perceived susceptibility 411 about the progression of his or her disease or about having a complication 412. Perceived severity refers to a patient's subjective assessment of the severity of a health problem and its potential consequences. The health belief model may consider that individuals who perceive a given health problem as serious are more likely to engage in behaviors to prevent the health problem from occurring (or reduce its severity). Perceived susceptibility refers to a patient's subjective assessment of risk of developing a health problem. The model may predict that individuals who perceive that they are susceptible to a particular health problem will engage in behaviors to reduce their risk of developing the health problem.

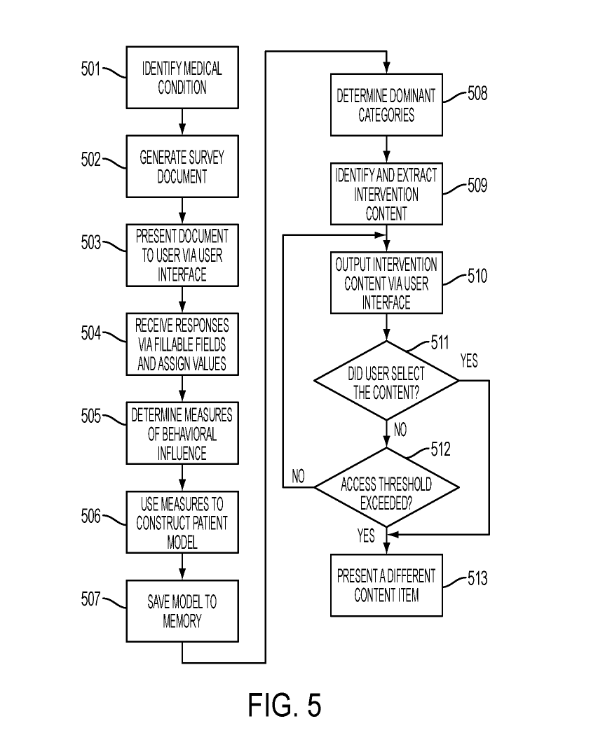

FIG. 5 is a flow diagram showing how the system may develop and apply a patient-specific model. In FIG. 5, one or more devices of the system will identify a medical condition of a patient 501 by receiving it from a user interface, extracting it from a patient profile, or otherwise obtaining it via user input or an external source. The system will automatically generate an electronic survey document 502 based on the medical condition by accessing a data set of questions and categories, and by extracting relevant questions that correspond to the medical condition. The system will assemble the relevant questions into the survey document. The survey document will include a set of fillable data entry fields, in which each fillable data entry field corresponds to a question that corresponds to a category of behavioral influence. Each category will correspond to a domain of desired patient activity.

The system will cause a user interface of an electronic device to output the survey document to the patient 503. When the system receives responses to each of the questions via the fillable fields as presented on the user interface of the electronic device, the system will assign a value to each response 504. For each of the categories that are associated with the patient's medical condition, the system will use the values of the responses calculate a patient-specific measure of behavioral influence 505 for each domain with which the category is associated. The system will then automatically construct a patient model 506 so that the model comprises the calculated patient-specific measures of behavioral influence for each domain and category. The system will save the model to a computer-readable memory 507.

Once the model is created, a system may use the model to select one or more dominant categories of behavioral influence for the patient for each domain 508. For example, the system may periodically access a database of intervention content using the model to select and extract one or more intervention content items for the patient 509 so that each extracted intervention content item is associated with the medical condition, a domain that relates to the medical condition, and a dominant measure of behavioral influence for the patient as determined from the model. For example, the recommendation system may use the constructed model to rank a set of candidate content items and extract one or more candidate content items having a rank that exceeds a threshold. The system will then output 510 the recommended intervention content item(s) to the patient via a user interface of an electronic device, such as a display. As noted above, the system may output the content directly to the patient, or indirectly to the patient by passing the content to an interface controller, which will in turn output the content to an electronic device that the patient is using.

Optionally, to ensure that the user reviews the content item and/or is interested in any presented item, then the system may determine whether the patient selected the outputted item for viewing 511, such as by activating a selection sector of the user interface. If the patient did not select the outputted item, then the system may present the extracted content item again the next time that the patient accesses the system 510. The system may continue to present the item until either the patient selects it for viewing or after a threshold number of access events 512 (e.g., a number of times that the user accessed the system without selecting the content, or a threshold period of time on the system without selecting the content item. After the threshold number of access events, or after the patient selects the content item), the system may then present a different recommended content item to the user 513.

As noted above, there are many domains of self-care behavior for disease management and general wellness, such as staying active, eating healthy, taking medications, doing lab tests, healthy coping with chronic conditions, etc. The survey questions will each relate to one or more of these self-care domains. Each self-care domain also is associated with a set of intervention content that educates and encourages the person to improve self-care in that domain. Intervention content may exist in various electronic formats, including electronic documents of text and images, videos, audio tracks, learning courses, and games.

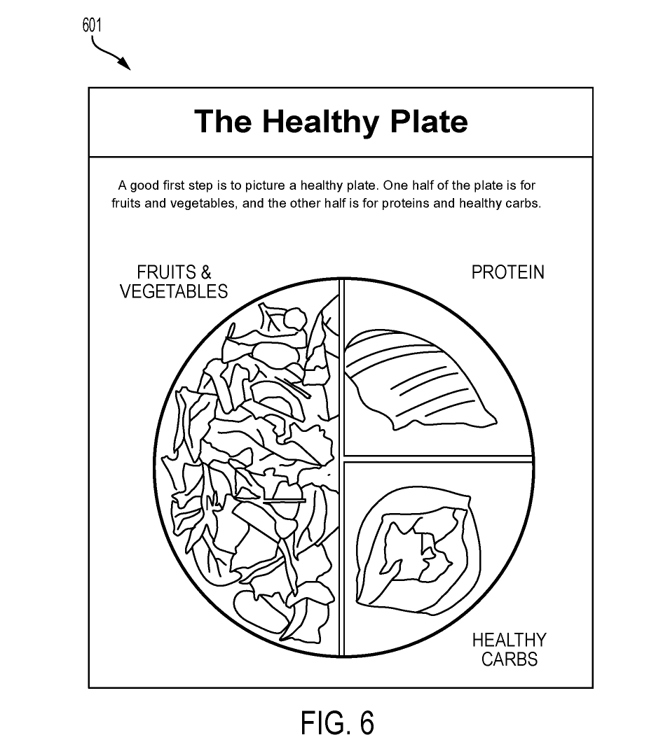

An example of intervention content for the domain of monitoring vitals may be a video of How to Test your Blood Sugar. Another example of intervention content for the domain of healthy eating is the brochure 601 shown in FIG. 6, which the system may store as an electronic data file for presentation to a patient. Each item of intervention content may be stored in association with metadata corresponding to various influencers, categories and/or diseases so that the system may recommend available content having metadata that corresponds to the patient-specific model. For example, the system may recommend content for behavioral areas where the patient is strong, with the goal being to give the patient a feeling of accomplishment and confidence by presenting content that is familiar to them. In addition or alternatively, the system may select content associated with behavioral influencers that are progressively more difficult for the patient to challenge their knowledge and confidence. By providing both content that is associated with positive aspects of the model and content associated with behavioral influences for which the patient needs improvement, the system keep the patient engaged and feel like he or she is learning.

To select content, the system may weight a set of available content based on the user's primary disease-specific category. The system may determine the primary category using any suitable process, such as by prompting the user response to a survey question indicating what domains the patient is strong in or best at.

The system may score each piece of content that matches the selected category with a first value (e.g., s 0.6). If the content does not match the selected value, it may be given a score that is lower than the first value (e.g., 0.1 or 0). The system may compare the user's self-efficacy values in each category against the values assigned to each piece of content and use as a distance function ratings values that are close together high and values that are further apart low. The system may normalize the scores for each content item to between 0 and 1, with 1 representing matching values and 0 representing values that furthest apart, or as far apart as possible on the scale. The system may rate content by matching the category of user interest, matching factors related to the specific behavior modification theory (Self-Efficacy in the working example), and a decay function that lowers the value of viewed or content presented multiple times and not used.

The system may use a weight function to emphasize specific areas. For example, the system may increase scores for content that emphasizes areas where the user's self-efficacy is medium-to-high and provides a medium amount of emphasize to the high ranking area. This may push the areas that the patient is initially best at towards the top of the ranking scheme. As the content is decayed or consumed (viewed) by the patient, the lower self-efficacy content will rise in the rankings to provide a greater challenge to the patient. The system may rate content in high ranking areas as 1 and the content in the other areas as 0, although other values may be used. The system will sum the values together to arrive at a total score for the content item. It may multiply the score by a decay factor representing a period of time or number of access events after which the system presented the content item has been viewed. Objects that have been recommended recently and viewed (or not viewed after a threshold number of access events) may be pushed down to or near the bottom the rankings.

The system may select the extracted content items using any suitable process, such as by choosing five content items in the following manner: (1) selecting the first two items from the highest scoring content; (2) selecting two items from the second highest scoring content that do not have the same primary category as the first content; and (3) selecting a final item from the third highest scoring content that does not come from the same category as the previous two recommendations.

If the patient did not completely respond to the survey, then the system also may include a “default” set of content items to present to the patient based on the patient's medical condition.

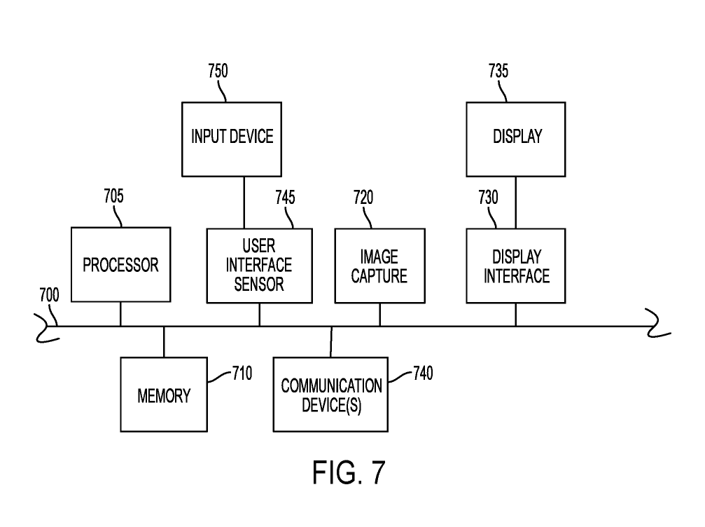

FIG. 7 depicts an example of internal hardware that may be included in any of the electronic components of the system, such as the user electronic device, or the remote server. An electrical bus 700 serves as an information highway interconnecting the other illustrated components of the hardware. Processor 705 is a central processing device of the system, configured to perform calculations and logic operations required to execute programming instructions. As used in this document and in the claims, the terms “processor” and “processing device” may refer to a single processor or any number of processors in a set of processors. Read only memory (ROM), random access memory (RAM), flash memory, hard drives and other devices capable of storing electronic data constitute examples of memory devices 710. A memory device may include a single device or a collection of devices across which data and/or instructions are stored.

An optional display interface 730 may permit information from the bus 700 to be displayed on a display device 745 in visual, graphic or alphanumeric format. An audio interface and audio output (such as a speaker) also may be provided. Communication with external devices may occur using various communication devices 740 such as a transmitter and/or receiver, antenna, an RFID tag and/or short-range or near-field communication circuitry. A communication device 740 may be attached to a communications network, such as the Internet, a local area network or a cellular telephone data network.

The hardware may also include a user interface sensor 745 that allows for receipt of data from input devices 750 such as a keyboard, a mouse, a joystick, a touchscreen (which may be part of the display), a remote control, a pointing device, a video input device and/or an audio input device. Data also may be received from an imaging capturing device 720 such as a scanner or camera.

In some embodiments, the system may use additional hardware components, such as an automated glucometer, wearable fitness tracker, sleep monitor, or other biometric device and use data received from the device in its decision making process when selecting content to be delivered to a user. For example, a patient whose glucometer data shows usage below threshold frequency, or whose sleep monitor shows average nightly sleep below a threshold amount, may be given content about glucometer usage or improving sleeping habits, respectively.

In other embodiments, the system may include a clock circuit and or a positioning system (such as a Global Positioning System sensor) to detect a time or location and use that information to determine recommended content to provide to the patient. For example, if a patient is interacting with the system around a scheduled meal time or from the location of a restaurant or their kitchen, the system may we increase the score of content related to food or healthy eating higher. Likewise, at the pharmacy or around scheduled medication times, content on medication could be scored higher. Close to scheduled sleeping times, reducing risks content could be scored higher.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method of selecting content for wellness or disease management and delivering the content to a patient, the method comprising:
by an electronic device having a processing device and a display device, executing programming instructions that cause the processing device to:
identify a medical condition of a patient;
automatically generate an electronic survey document comprising a set of data entry fields, in which each data entry field corresponds to a question that corresponds to a category of behavioral influence, and wherein each category corresponds to a domain of desired patient activity;
cause a user interface of the electronic device to use the display device to output the survey document to the patient;
receive, via the fillable fields as presented on the user interface of the electronic device, responses to each of the questions;
assign a value to each response;
for each of the categories, use the values of the responses to calculate a patient-specific measure of behavioral influence for each domain with which the category is associated;
automatically construct a patient model so that the model comprises the calculated patient-specific measures of behavioral influence for each domain and category;
use the model to determine one or more dominant categories of behavioral influence for the patient for each domain;
periodically access a database of intervention content and use the model to extract one or more intervention content items for the patient so that each extracted intervention content item is associated with the medical condition, a domain that relates to the medical condition, and a dominant measure of behavioral influence for the patient as determined from the model; and
output the extracted one or more intervention content items to the patient via a user interface.

2. The method of claim 1, wherein extracting the one or more intervention content items comprises using the model to rank a set of candidate content items and extracting candidate content items having a rank that exceeds a threshold.

3. The method of claim 1, wherein calculating the patient-specific measure of behavioral influence for each domain comprises using the assigned values for each response to assign a value to a plurality of facets of behavioral influence for the domain.

4. The method of claim 3, wherein automatically constructing the patient model for each category comprises:
saving the values of each facet of behavioral influence for each domain to an electronic file in a memory device; and
including in the model an assessment of the patient's perceived severity level, or of the patient's perceived susceptibility to disease or about having a complication.

5. The method of claim 1, wherein extracting the one or more intervention content items and outputting the extracted one or more intervention content items comprise:
selecting a first intervention content item associated with behavioral areas in the model for which the patient is relatively strong;
selecting a second intervention content item associated with behavioral areas in the model for which the patient is less strong; and
outputting both the first intervention content item and the second intervention content item to the patient.

6. The method of claim 1, wherein periodically extracting and outputting the one or more intervention content items comprises:
extracting a first content item;
presenting the first content item to the patient each time the patient accesses the user interface until the patient either selects the first content item for viewing, or fails to select the first content item for viewing after a threshold number of access events; and
after the patient either selects the first content item for viewing or fails to select the first content item for viewing after a threshold number of access events, then when the patient next accesses the user interface, extracting a second content item and presenting the second content item to the patient.

7. The method of claim 1, wherein periodically extracting and outputting the one or more intervention content items comprises extracting and outputting at least a first content item that is associated with positive aspects of the model and a second content item that is associated with one or more behavioral influences for which the patient needs improvement.

8. The method of claim 1, wherein periodically extracting the one or more intervention content items comprises:
selecting a primary category of behavioral influence from the dominant categories of behavioral influence;
assigning a first score to each intervention content item that matches the primary category, so that each intervention content item that matches the primary category has a common score value;
assigning a second score to each intervention content item that does not match the primary category, so that the intervention content items that do not match the primary category have various value and is assigned a score value that is less than the common score value;
comparing self-efficacy values for the patient against the score values assigned to each intervention content item and normalize the score values for each intervention content item based on the intervention content item's distance from the self-efficacy values; and
using the normalized score values to identify the intervention content items that are extracted.

9. The method of claim 8, further comprising, before the comparing, increasing the score values for content that is associated with category for which the patient has at least a threshold self-efficacy value.

10. A system for selecting content for wellness or disease management and delivering the content to a patient, the system comprising:
a processing device;
a display device;
a database of intervention content; and
a non-transitory memory containing programming instructions that are configured to cause the processing device to:
identify a medical condition of a patient,
automatically generate an electronic survey document comprising a set of data entry fields, in which each data entry field corresponds to a question that corresponds to a category of behavioral influence, and wherein each category corresponds to a domain of desired patient activity,
cause the display device to output the survey document to the patient as at least a portion of a user interface,
receive, via the fillable fields as presented on the user interface, responses to each of the questions,
assign a value to each response,
for each of the categories, use the values of the responses to calculate a patient-specific measure of behavioral influence for each domain with which the category is associated,
automatically construct a patient model so that the model comprises the calculated patient-specific measures of behavioral influence for each domain and category,
use the model to determine one or more dominant categories of behavioral influence for the patient for each domain,
periodically access the database of intervention content and use the model to extract one or more intervention content items for the patient so that each extracted intervention content item is associated with the medical condition, a domain that relates to the medical condition, and a dominant measure of behavioral influence for the patient as determined from the model, and
cause the display device to output the extracted one or more intervention content items to the patient.

11. The system of claim 10, wherein the instructions to extract the one or more intervention content items are configured to cause the processing device to use the model to rank a set of candidate content items and extract candidate content items having a rank that exceeds a threshold.

12. The system of claim 10, wherein the instructions to calculate the patient-specific measure of behavioral influence for each domain comprise instructions that are configured to cause the processing device to use the assigned values for each response to assign a value to a plurality of facets of behavioral influence for the domain.

13. The system of claim 12, wherein the instructions to automatically construct the patient model for each category comprise instructions that are configured to cause the processing device to:
save the values of each facet of behavioral influence for each domain to an electronic file in a memory device; and
include in the model an assessment of the patient's perceived severity level, or of the patient's perceived susceptibility to disease or about having a complication.

14. The system of claim 10, wherein the instructions to extract the one or more intervention content items and output the extracted one or more intervention content items comprise instructions that are configured to cause the processing device to:
select a first intervention content item associated with behavioral areas in the model for which the patient is relatively strong;
select a second intervention content item associated with behavioral areas in the model for which the patient is less strong; and
output both the first intervention content item and the second intervention content item to the patient.

15. The system of claim 10, wherein the instructions to extract and output the one or more intervention content items comprise instructions that are configured to cause the processing device to:
extract a first intervention content item;
cause the display device to present the first intervention content item to the patient each time the patient accesses the user interface until the patient either selects the first content item for viewing, or fails to select the first intervention content item for viewing after a threshold number of access events; and
after the patient either selects the first intervention content item for viewing or fails to select the first content item for viewing after a threshold number of access events, then when the patient next accesses the user interface, extract a second intervention content item and present the second content item to the patient.

16. The system of claim 10, wherein the instructions to periodically extract and output the one or more intervention content items comprise instructions to extract and output at least a first content item that is associated with positive aspects of the model and a second content item that is associated with one or more behavioral influences for which the patient needs improvement.

17. The system of claim 10, wherein the instructions to periodically extract the one or more intervention content items comprise instructions that are configured to cause the processing device to:
select a primary category of behavioral influence from the dominant categories of behavioral influence;
assign a first score to each intervention content item that matches the primary category, so that each intervention content item that matches the primary category has a common score value;
assign a second score to each intervention content item that does not match the primary category, so that the intervention content items that do not match the primary category have various value and is assigned a score value that is less than the common score value;
compare self-efficacy values for the patient against the score values assigned to each intervention content item and normalize the score values for each intervention content item based on the intervention content item's distance from the self-efficacy values; and
use the normalized score values to identify the intervention content items that are extracted.

18. The system of claim 17, further comprising instructions to, before the comparing, increase the score values for content that is associated with category for which the patient has at least a threshold self-efficacy value.

19. A system for selecting content for wellness or disease management and delivering the content to a patient, the system comprising:
a processing device;
a display device;
a database of intervention content; and
a non-transitory memory containing programming instructions that are configured to cause the processing device to:
identify a medical condition of a patient,
automatically generate an electronic survey document comprising a set of data entry fields, in which each data entry field corresponds to a question that corresponds to a category of behavioral influence, and wherein each category corresponds to a domain of desired patient activity;
cause the display device to output the survey document to the patient as at least a portion of a user interface,
receive, via the fillable fields as presented on the user interface, responses to each of the questions,
assign a value to each response,
for each of the categories, use the values of the responses to calculate a patient-specific measure of behavioral influence for each domain with which the category is associated,
automatically construct a patient model so that the model comprises the calculated patient-specific measures of behavioral influence for each domain and category,
use the model to determine one or more dominant categories of behavioral influence for the patient for each domain,
access the database of intervention content and use the model to extract a first intervention content item for the patient so that the extracted first intervention content item is associated with the medical condition, a domain that relates to the medical condition, and a dominant measure of behavioral influence for the patient as determined from the model,
cause the display device to output the extracted first intervention content item to the patient each time the patient accesses the user interface until the patient either selects the first content item for viewing, or fails to select the first intervention content item for viewing after a threshold number of access events, and
after the patient either selects the first intervention content item for viewing or fails to select the first content item for viewing after a threshold number of access events, then when the patient next accesses the user interface, extract a second content item and present the second content item to the patient.

20. The system of claim 19, wherein the instructions to extract the first intervention content item comprise instructions that are configured to cause the processing device to:
select a primary category of behavioral influence from the dominant categories of behavioral influence;
assign a first score to each intervention content item that matches the primary category, so that each intervention content item that matches the primary category has a common score value;
assign a second score to each intervention content item that does not match the primary category, so that the intervention content items that do not match the primary category have various value and is assigned a score value that is less than the common score value;
compare self-efficacy values for the patient against the score values assigned to each intervention content item and normalize the score values for each intervention content item based on the intervention content item's distance from the self-efficacy values; and
use the normalized score values to identify first intervention content item.
